(19) United States
(12) Patent Application Publication
(10) Pub. No.: US 2026/0216540 A1
(43) Pub. Date: Jul. 30, 2026

(54) QUICK RELEASE FOR CLOSED-CIRCUIT REBREATHER

(71) Applicant: CAELI TECHNOLOGIES LTD, Nes Ziyyona (IL)

(72) Inventors: Nir Bloch, Nes Ziyyona (IL); Arie Kalo, Nes Ziyyona (IL); Izhak Rabinovitz, Nes Ziyyona (IL)

(21) Appl. No.: 19/147,165

(22) PCT Filed: Jan. 10, 2024
(86) PCT No.: PCT/IL2024/050035

§ 371 Date: Jul. 10, 2025

(30) Foreign Application Priority Data
Jan. 10, 2023 (IL) 299813

(51) Int. Cl. A62B 25/00; A45F 3/04; A45F 3/10; A62B 7/02; A62B 9/04

(52) U.S. Cl. CPC A62B 25/00; A45F 3/04; A45F 3/10; A62B 7/02; A62B 9/04; A45F 2003/045

(57) ABSTRACT

The present invention provides a system for quick replacement of a closed-circuit rebreather (CCR) unit, the CCR unit including a frame having front and back sides, the front side having one or more latches for fastening a back panel of a load-carrying backpack. The frame further includes one or more top brackets for mounting over one or more respective protruding ridges at the top of the back panel.

### FIELD OF THE INVENTION

The present invention is in the field of breathing systems, specifically closed-circuit rebreathers for prolonged ground use.

### BACKGROUND OF THE INVENTION

Self-contained breathing systems are designed to be worn by users working in conditions with insufficient oxygen or with hazardous levels of toxic gases. Typical environments requiring such breathing systems include underground tunnels and mines, as well as any other environment characterized by scarce air flow or smoke.

Self-contained breathing systems may be classified into closed-circuit and open-circuit systems. In open-circuit breathing systems, air exhaled by a user is discharged to the atmosphere. Although such open-circuit systems are simple and provide adequate protection, the high rate of gas usage and the weight and size of the required oxygen canister typically limit the duration of usage to no more than about 30 to 45 minutes.

Closed-circuit breathing systems, also known as closed-circuit rebreathers (CCRs), can provide extended effective usage of up to 3 to 4 hours. Extended use may be crucial for emergency work in hostile environments, such as in underground tunnels, mine rescue operations, and other confined areas with limited or scarce airflow.

A CCR generally comprises a breathing circuit having an oxygen cylinder with compressed oxygen, a counterlung (i.e., “breathing bag”), and a carbon dioxide (CO₂) absorber, such as a scrubber. The CCR may also include a method of cooling the scrubbed air for subsequent inhaling.

When using a CCR, air is inhaled and exhaled through the breathing port, and the gas is continually re-circulated in the closed breathing circuit, while only a small portion of the gas (if any) is released into the atmosphere. When a user inhales and exhales, about 4% of the oxygen within the re-circulated air is consumed and converted into CO₂. Oxygen consumed by the user is replenished by the oxygen supply while CO₂ is removed by the carbon dioxide absorber. The amount of oxygen and carbon dioxide contained in the circulated air is thus maintained at levels that ensure that the user can breathe safely.

Various CCRs have been developed to provide prolonged breathing time, such as those described in U.S. Pat. Nos. 4,362,153, 4,879,996, and 4,498,470. However, these CCRs exhibit various shortcomings, which may include: icing of valves, contamination of air supply by ambient air, overheating of the air within the system, complex cooling mechanisms, and/or insufficient usage time. For instance, while the CCR described in U.S. Pat. No. 4,362,153 enables a relatively prolonged usage/breathing time for a resting user (who typically breathes in about 7-10 liters of air per minute), it is designed to provide a constant oxygen pressure that is inadequate for an active user, who typically needs more than a 100 liters of air per minute (which causes the system to take in ambient air at the facepiece). Any attempt to rectify this situation results in a reduction of usage time of the CCR.

In addition to the disadvantages described above, a further disadvantage of current CCRs is the inconvenience of removing a first system and replacing it with a second system, especially given that the systems are heavy, and replacement must be done quickly during emergency operations. Reducing the time and increasing the safety of replacing an oxygen-depleted or otherwise inoperable system would improve operations. The above and other disadvantages of the prior art CCRs are overcome by the present invention.

### SUMMARY

The present invention provides a modular, closed-circuit rebreather (CCR) system including a closed-circuit rebreather (CCR) unit mounted to a load-carrying backpack worn by a user. The CCR unit comprising: (a) a frame (42) having front and back sides, the front side comprising: (i) one or more top brackets (48) for mounting over one or more respective protruding ridges at the top of a back panel of a load-carrying backpack (50); and (ii) one or more quick-release latches (46) for fastening said frame (42) to said back panel, and (b) elements for CCR operation mounted onto the back side of the frame comprising: a compressed oxygen cylinder (502), an oxygen regulator (506), a carbon dioxide (CO₂) absorber (504), an exhaust tube connector (302) for connecting a user exhaust tube (34), and an inhalation tube connector (304) for connecting a user's inhalation tube (36), wherein both the exhaust tube connector (302) and the inhalation tube connector (304) are quick-release connectors.

### BRIEF DESCRIPTION OF DRAWINGS

For a better understanding of various embodiments of the invention and to show how the same may be carried into effect, reference will now be made, by way of example, to the accompanying drawings, in which:

FIGS. 1A-1E are illustrations of a closed-circuit rebreather (CCR) system and its modular components, according to an embodiment of the invention. The modular components shown in FIGS. 1B-1E include: a breathing tube unit, a CCR unit, and a load-carrying backpack.

FIGS. 2A-2B are illustrations of front and side views of the modular load-carrying backpack of the present invention.

FIGS. 3A-3B are illustrations of front and side views of the CCR unit of the present invention.

FIGS. 4A-4B are illustrations of side views of the CCR unit and the modular load-carrying backpack, indicating elements facilitating the mounting of the CCR unit onto the modular load-carrying backpack, according to an embodiment of the invention.

FIG. 5 illustrates various possible configurations of backpack-CCR unit assemblies, according to embodiments of the invention.

FIG. 6 is an illustration of a CCR unit of the CCR system, shown from the back side, with the counterlung removed, exposing the main operational elements, according to an embodiment of the invention.

FIGS. 7A-7C are illustrations of the CCR unit and a back panel of the load-carrying backpack, indicating how the CCR unit mounts to the back panel, according to an embodiment of the invention.

FIGS. 8A-8B are close-up illustrations of the CCR unit and a back panel of the load-carrying backpack, indicating how the CCR unit mounts to the back panel, according to an embodiment of the invention.

FIGS. 9A-9B are illustrations of the latch of the CCR unit being fit into a slot of a frame of the CCR unit, according to an embodiment of the invention.

FIGS. 10A-10D are illustrations of a latch of the CCR unit that clasps onto the back panel of the load-carrying backpack to secure the CCR unit to the load-carrying backpack, according to an embodiment of the invention.

FIG. 11 is a flowchart of steps performed in replacing the modular CCR unit, according to an embodiment of the invention.

Structural details of the invention are shown to provide a fundamental understanding of the invention, the description, taken with the drawings, making apparent to those skilled in the art how the several forms of the invention may be embodied in practice.

### DETAILED DESCRIPTION

Emergency rescue personnel, tunnel fighting soldiers, and other workers and personnel that are required to operate under oxygen-depleted or air-contaminated environments, such as underground tunnels, collapsed mines, tunnels, high mountains (with “thin-air”), toxic environments (for example, near a toxic waste plant), etc., must use a breathing system that provides oxygen.

Due to physical limitations on the size and weight of standard breathing systems, such systems can provide oxygen only for short periods before the oxygen is depleted. To increase the operational time, closed-circuit rebreathers (CCRs) have been developed. Such systems extend the operational time, but when working time is prolonged, they still must be replaced while work is in progress. Current CCR systems are cumbersome and do not provide quick and simple replacement.

The present invention thus provides a system that is designed in such a way that the CCR unit is modular, meaning it may be quickly replaced when elements necessary for operation, such as the oxygen canister or the CO₂ scrubber need replacement, or if there is a malfunction in any of the system's components. For time-critical operations, i.e., emergency work, replacement of the modular CCR unit, according to the methods described herein, typically requires less time than replacement of individual CCR elements/components, such as the oxygen canister and the CO₂ scrubber. Replacement of the entire modular CCR unit alone is also more efficient than having to maintain and replace a complete backpack CCR system that includes the load-carrying backpack as well as the breathing tubes and mouthpiece.

Accordingly, the present invention provides a system (20) comprising a closed-circuit rebreather (CCR) unit (40).

The CCR unit typically includes a frame having front and back sides, with elements for CCR operation mounted to the back side of the frame. The front side has one, two, three, or more latches for fastening the frame to a back panel of a load-carrying backpack. In specific embodiments, the latches are an integral part of the frame. In alternative embodiments, the latches are protruding latches that are mounted onto the frame, thereby enabling replacement of a damaged latch when needed.

In specific embodiments, the CCR unit (40) comprises: (a) a frame (42) having front and back sides, the front side comprising: (i) one or more top brackets (48) for mounting over one or more respective protruding ridges at the top of a back panel of a load-carrying backpack (50); and (ii) one or more quick-release latches (46) for fastening said frame (42) to said back panel for enabling quick mounting and quick-release of the frame onto and from said back panel, and (b) elements for CCR operation mounted onto the back side of the frame comprising: a compressed oxygen cylinder (502), an oxygen regulator (506), a carbon dioxide (CO₂) absorber (504), an exhaust tube connector (302) for connecting a user exhaust tube (34), and an inhalation tube connector (304) for connecting a user's inhalation tube (36), wherein both the exhaust tube connector (302) and the inhalation tube connector (304) are quick-release connectors.

In certain embodiments, each latch (46) includes a set of spring elements (902) that maintain tension of the latch on the back panel while the CCR unit is mounted on the back panel, until the latch (46) is pulled, outwardly, for releasing the frame (42) from the back panel. In specific embodiments, the spring elements (902) are Z-shaped. In further specific embodiments, the Z-shaped spring elements constitute part of the latch, and may be made of the same material during manufacturing. Alternatively, the spring elements (902) can be in any suitable shape and can be made of the same or different material of the latch (46), such as a metal spring placed within a plastic/polymer latch (46).

In certain embodiments, the frame further includes one or more top brackets (48) for mounting over one or more respective protruding ridges at the top of the back panel, thereby enabling easy mounting of the frame (42) onto the back panel. When the frame (42) is lowered onto the back panel, said latches (46) interlock with the back panel, securing it in place. Similarly, when the latches (46) are released, the frame still rests on the back panel and does not drop off, but rather must be lifted off, that is, by lifting the top brackets (48) of the frame off of the protruding ridges at the top of the back panel).

In certain embodiments of the system according to any of the embodiments above, the main elements/components for CCR operation that are mounted to the back side of the frame (42) include: a compressed oxygen cylinder, an oxygen regulator, and a carbon dioxide (CO₂) absorber. In addition, the CCR unit (40) may further comprise an exhaust tube connector (302), for connecting a user exhaust tube, and an inhalation tube connector for connecting a user inhalation tube, with both of the tube connectors being quick-release connections, such that the CCR unit is quickly disconnected and a new CCR unit reconnected both to the breathing tubes as well as to the load-carrying backpack. Notably, although the system according to the invention is designed to enable quick and simple release of the entire frame (42) with all its components, such components may be removed-from and attached-to the frame as needed for maintenance or replacement.

In certain embodiments of the system according to any of the embodiments above, the CCR unit (40) may further comprise a breathing tube unit (30) comprising: a user mouthpiece (32), a user exhaust tube (34), and a user inhalation tube (36), wherein the user exhaust tube (34) and the user inhalation tube (36) connect the user mouthpiece (32) to the respective exhaust and inhalation tube connectors (302, 304).

In certain embodiments, the system according to any of the embodiments above further comprises a load-carrying backpack (50) that comprises shoulder straps (52) for ease of carrying, which are connected-to or part-of a back panel (56), onto which the frame (42) is designed to be mounted.

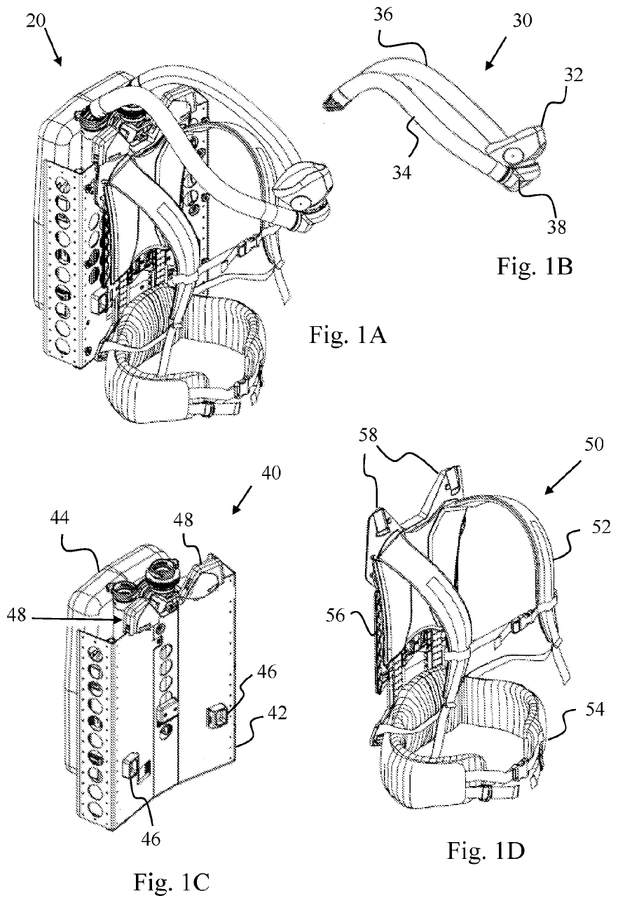

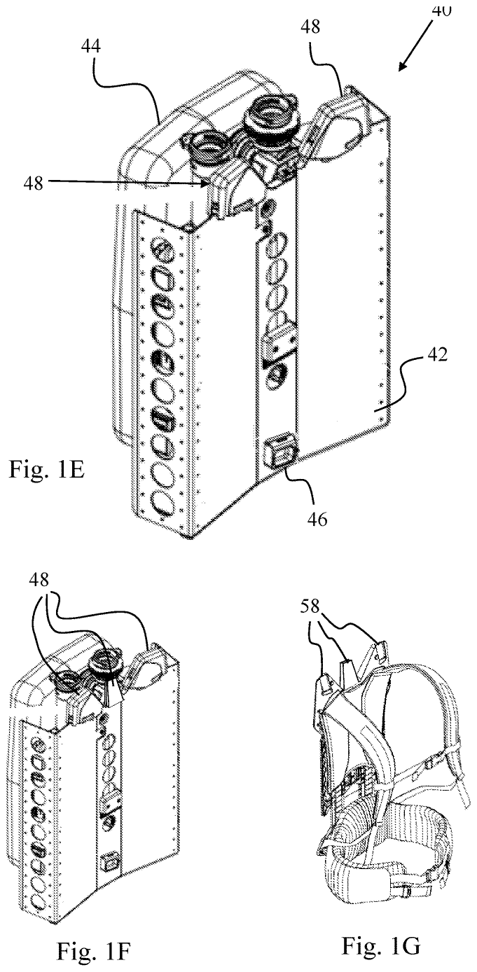

In specific embodiments of the system according to any of the embodiments above, the frame (42) is wider than the back panel (56), which allows carrying wider components or assembly. In further specific embodiments thereof, the one or more latches (46) are a pair of latches positioned to clasp the back panel (56) at the outer edge of each side of the back panel, such that the latches are accessible to a person reaching around the back of the CCR unit while the CCR unit is mounted onto the back panel. In alternative specific embodiments, the latches (46) are associated with a pulling cable/wire or any other release mechanisms, which allows the positioning of the latches (46) to clasp the back panel (56) anywhere, since they can be simultaneously released remotely, for example by pulling the cable or pressing a release-button of a release mechanism. In additional or alternative embodiments, one or more of the latches (46) may be positioned to latch the bottom of the back panel (see illustrated in FIG. 1E).

In certain embodiments of the system according to any of the embodiments above, the one or more latches are mounted onto said frame (42) within a dedicated frame slot (800). In specific embodiments thereof, each spring element (902) is grooved to catch an edge of the frame slot.

The design of the latches (46) is such that it enables quick mounting and clamping of the frame (42) onto the back panel (56). For instance, in specific embodiments of the system according to any of the embodiments above, each latch (46) comprises ridges (920, 922) on each (opposing) side that fit inside the frame slot (800), each ridge may have an angled side for snapping into the frame slot and for maintaining the tension of the latch against the front and back sides of the frame while allowing forward and backward motion of the latch across the surface. Notably, any suitable design can be used, and the latches (46) of the invention are not limited to those explicitly exemplified in the figures.

In further examples, the latches (46) are manufactured by additive 3D manufacturing as single pieces. The latches may be made by any suitable technique, such as molding, blow-molding, CNC, and 3D-printing. The latches may be made, for example, of polyamide or other materials with similar degrees of strength and elasticity, such as other polymers, metals, or metal-alloys, or a combination thereof. In specific embodiments, the latches are made essentially entirely of polyamide. In alternative embodiments, the latches are manufactured from several materials and are assembled later for use, for example, the main body of the latch is made of a polymer, for example, by additive 3D, press molding or CNC, and the spring element within the latch is made of metal or metal alloy (in any known technique) and is then integrated with the latch's main body.

In certain embodiments, the system according to any of the embodiments above further includes a counterlung (44) designed to provide air to the inhalation tube after scrubbing by the CO₂ absorber (504) and the addition of additional oxygen from the oxygen cylinder (502).

In certain embodiments, the system according to any of the embodiments above further includes a cooling system (508) mounted in such a way as to receive air exiting from the CO₂ absorber (504), wherein the cooling unit is designed to cool the air exiting the CO₂ absorber (504) before returning it to the user for breathing, thereby providing the user with breathable air in a suitable breathing temperature.

The present invention further provides a method for enabling a user of a CCR system to quickly and easily replace essential CCR components to enable prolonged and continuous work under conditions that require the use of a CCR system, wherein the method is carried out using the system according to any of the embodiments above. Accordingly, the method of the invention comprises the steps of: (i) providing the system according to any of the embodiments above and when needed, for example, when the system is depleted or damaged; (ii) disconnecting the breathing tube unit (30) from the frame (42), i.e., by disconnecting the exhaust tube (34), and a user inhalation tube (36) from their respective exhaust and inhalation tube connectors (302, 304) within the frame; (iii) disconnecting the latches (46) to enable disconnecting the frame from the back panel; (iv) dislodging the frame (42) from the back panel (56) by lifting the frame's brackets (48) off of the protruding ridges (58) at the top of the back panel of a load-carrying backpack (50); and placing a new frame (42) with fresh CCR components onto the back panel following the steps above in reverse order.

In specific embodiments, the above method can be carried out while the load-carrying backpack (50) is still on the user's back, which saves replacement time and facilitates continuous and uninterrupted work.

The invention will now be illustrated by reference to the accompanying drawings which are to be considered only as representative examples of possible embodiments of packages of the invention. Alterations and modifications may be made by those having ordinary skill in the art without departing from the scope of the invention. Therefore, it must be understood that the illustrated embodiment has been set forth only for the purposes of example and that it should not be taken as limiting the invention as defined by the following invention and its various embodiments and/or by the following claims. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

FIGS. 1A-1G are illustrations of a closed-circuit rebreather (CCR) system (20) and its modular components as mentioned hereinabove, namely a breathing tube unit (30), a CCR unit (40), and a load-carrying backpack (50), shown respectively in FIG. 1B, FIG. 1C, and FIG. 1D. As described further hereinbelow, the three components of the CCR system (20) can be quickly detached and reattached to reassemble the CCR system (20), thereby increasing the efficiency of replacing depleted systems in the field.

FIG. 1A illustrates an assembled CCR according to one embodiments of the invention. FIG. 1B illustrates a breathing tube unit (30) that includes a mouthpiece (32), which is connected to the user exhaust tube (34) and the user inhalation tube (36). A mouthpiece regulator (38) controls the venting of inhaled and exhaled air. In certain embodiments, the mouthpiece regulator (38) further includes an additional discharge valve for discharging air and/or liquid water accumulated and condensed within the mouthpiece. In alternative or additional embodiments, the mouthpiece regulator (38) also regulates the amount and pressure of the inhaled air.

As shown in FIG. 1C, the CCR unit (40) includes a frame (42), to which are attached operational elements of closed-circuit rebreathing, as described further hereinbelow. The frame is made of a rigid material, such as plastic, aluminum, metal, polycarbonate, etc. A counterlung (44) of the CCR unit (40) is positioned at the back of the CCR unit (behind or on top of the other elements). Also shown are latches (46) which are designed to affix the CCR unit (40) (via its frame (42)) to the load-carrying backpack (50), and one or more top brackets (48) by which the CCR unit (40) is mounted onto the load-carrying backpack (50), also described further hereinbelow. As illustrated in FIG. 1C, two latches (46) can be used to affix the CCR unit (40) to the load-carrying backpack (50). Alternatively, and as illustrated in FIG. 1E, a single latch (46) can be used to affix the CCR unit (40) to the load-carrying backpack (50). It is noted that the release of such latches (46) can be done either separately, meaning that each latch is pulled separately by the user's hands, in which case, no more than two latches can be used (since the user has only two hands) and such latches need to be positioned in an accessible position. Alternatively, the pulling of all latches can be done simultaneously by pulling, for example, a cord or a string (not shown) connected to all the latches (46), in which case, more than two latches can be used, and they do not necessarily have to be in manually accessible positions.

As shown in FIG. 1D and FIG. 1G, the load-carrying backpack (50) includes shoulder straps (52), a waistband (54), and a back panel (56). The backpack is referred to herein as “load-carrying” because the back panel (56) is designed to have additional elements attached, such as Modular Lightweight Load-carrying Equipment (MOLLE) packs. The back panel may also be supported by the waistband to assist the user in the load-carrying.

At the top of the back panel (56) are one or more protruding top ridges (58) onto which the respective top brackets (48) of the CCR unit (40) are mounted. FIG. 1D illustrates a back panel with two such protruding top ridges (58), and FIG. 1G illustrates a back panel with three such protruding top ridges (58). It should be noted that the location of such ridges can vary, and they do not necessarily need to be at the top of the back panel as illustrated in the figures.

As illustrated, the top brackets (48) can be concave, cup-shaped brackets, that are sized to fit over the top ridges (58). To mount the CCR unit (40) onto the load-carrying backpack (50), the top brackets (48) are fit onto respective protruding top ridges (58) and the latches (46) snap onto the back panel (56), as described further hereinbelow. FIG. 1C and FIG. 1D illustrate a load-carrying backpack (50) having two top ridges (58) and a compatible frame (42) having two corresponding top brackets (48), as well as two latches (46) positioned at opposite sides of the frame. An alternative configuration is illustrated in FIG. 1F and FIG. 1G that illustrate a load-carrying backpack (50) having three top ridges (58) and a compatible frame (42) having three corresponding top brackets (48), as well as a single latch (46) positioned at the bottom section of the frame. Notably, these are examples only, and any combination of these elements can be used (e.g., one ridge and 3 latches, 3 ridges and 1 latch, etc.).

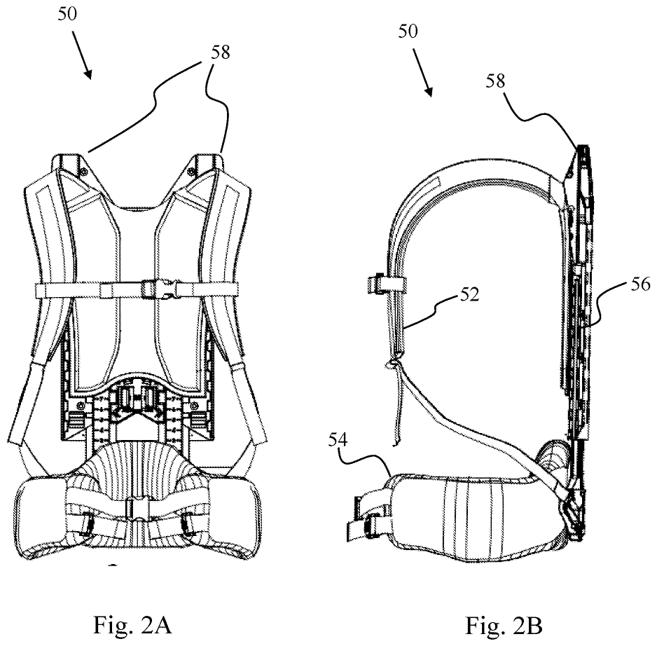

FIGS. 2A-2B are illustrations of front and side views of the load-carrying backpack (50) of the present invention, FIG. 2A showing a front view, and FIG. 2B showing a side view. Shown are elements that are also shown in the perspective views of FIGS. 1A-1D, in particular the shoulder straps (52), the waistband (54), the back panel (56), and the top ridges (58) of the back panel.

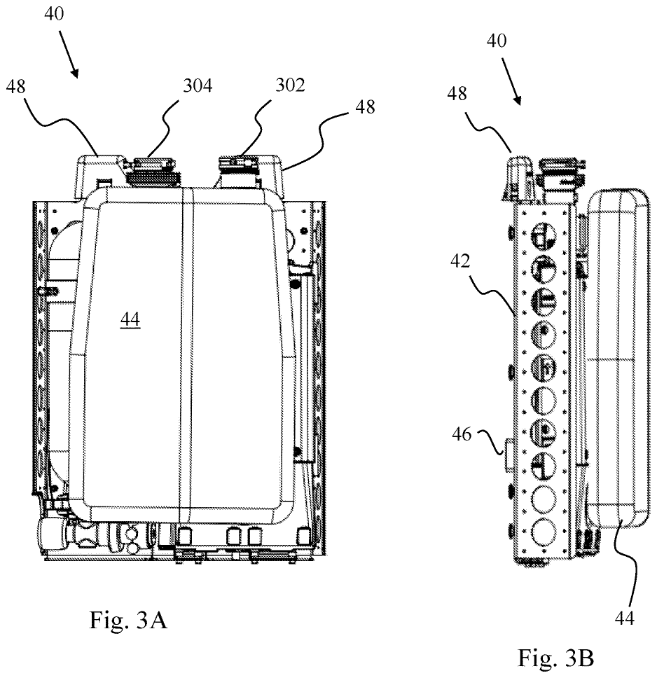

FIGS. 3A-3B are illustrations of front and side views of the CCR unit of the present invention, FIG. 3A showing a front view, and FIG. 3B showing a side view. Shown are elements that are also shown in the perspective views of FIG. 1A and FIG. 1F, in particular the CCR unit frame (42), the counterlung (44), the latches (46), and the top brackets (48). The width of the cup-shaped top brackets is shown in the side view of FIG. 3B. Also shown in FIG. 3A are the tube quick-release connectors that connect the CCR unit (40) to the breathing tubes of the breathing tube unit (30), these connectors being an exhaust tube connector (302), which connects the user exhaust tube (34), and an inhalation tube connector (304), which connects the user inhalation tube (36). Both tube connectors employ quick-release connections known in the art, such as spring-release connections that click on and which are released by pressing, such as buttons at the edges of the connectors.

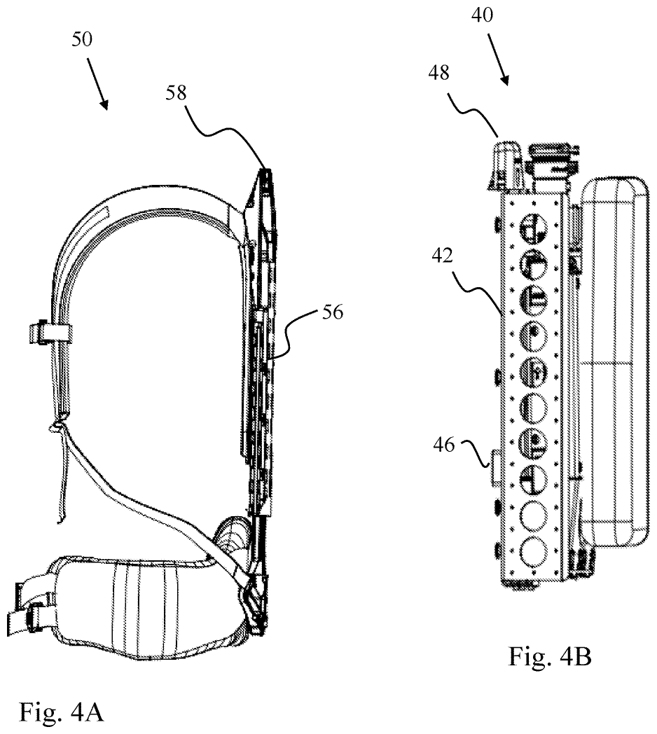

FIGS. 4A-4B are illustrations of side views of the CCR unit (40) and the load-carrying backpack (50), indicating elements facilitating mounting of the CCR unit onto the modular load-carrying backpack, according to an embodiment of the invention. Key elements of the system quick release and quick attachment of the CCR unit (40) to the load-carrying backpack (50) are: (i) the latches (46) of the CCR unit, which latch onto the back panel (56) of the load-carrying backpack, and (ii) the top brackets (48) of the CCR unit, which fit over the top ridges (58) of the back panel. Dashed arrows in the figure indicate these two points of connection. When assembling, the top brackets (48) of the CCR unit (40) are first mounted onto the top ridges (58) of the back panel, and then, when the frame is pushed against the back panel (56), the latches snap onto the back panel thereby securing the CCR unit (40) to the load-carrying backpack (50).

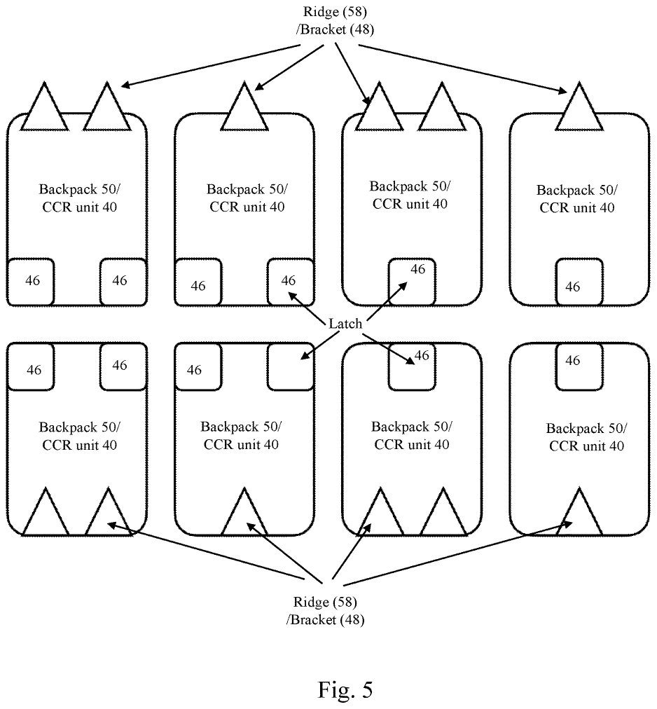

FIG. 5 illustrates 8 possible configurations for assembling/mounting the CCR unit (40) onto the backpack (50). In this figure, the backpack (50) is illustrated as having one or two ridges (58) that can be positioned at the upper part or at the lower part of the backpack, onto which suitable brackets (48) in the CCR unit (40) may be mounted. Consequently, the position of the latches (46) in the CCR unit and their respective grooves/holes in the back panel of the backpack (50) can be at the lower part or at the upper part of the CCR unit (40) to enable easy access thereto. The possibilities for arranging the ridges (58), brackets (48), and latches (46) are numerous and can include 3, 4, 5, or more ridges (58) and brackets (48) positioned at various locations, and the number and position of latches (46) can also vary and be 1, 2, 3, 4, 5, or more.

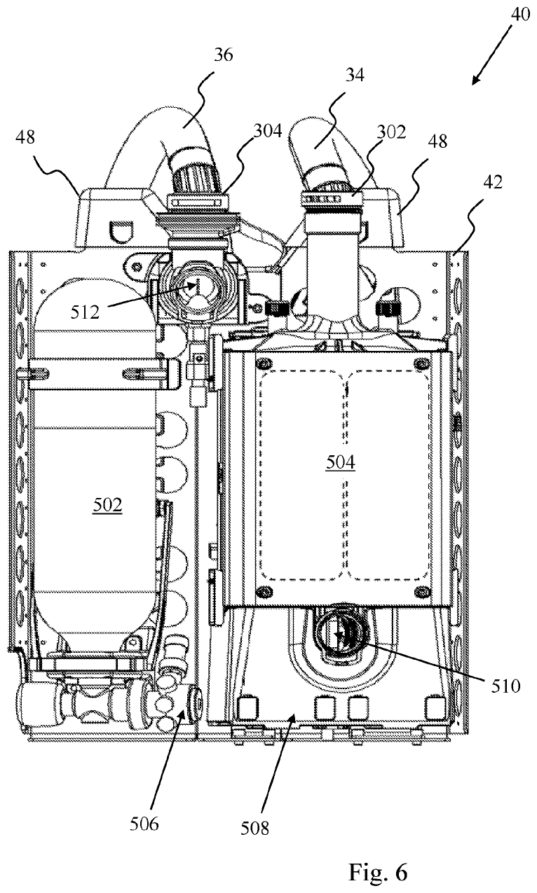

FIG. 6 is an illustration of a CCR unit (40) of the CCR system (20) according to some embodiments of the invention, shown from the back side, with the counterlung (44) removed, exposing the main operational elements involved in the processing of exhaled air by the CCR unit, according to an embodiment of the invention. As illustrated, the main operational elements of the CCR unit (40) include a compressed oxygen tank/cylinder (502) for refreshing the oxygen used by the user, i.e., providing new oxygen to replace the oxygen consumed by the user, and an absorber/scrubber (504) for removal of CO₂ produced during the user's breathing. Also shown are an oxygen cylinder regulator (506) attached to the oxygen tank (502) to regulate oxygen flow and pressure within the rebreather, and a cooling system (508) for cooling the air exiting from the CO₂ absorber (504). The CO₂ absorber (504) is designed to hold CO₂ absorber material, which may be any material known in the art, such as quicklime (calcium oxide), magnesium silicate hydroxide, sodium hydroxide, potassium hydroxide, lithium hydroxide and olivine powder, and which may be provided in any known form, such as solids, powders, sacks holding powder, etc. The cooling system (508) typically includes a heat exchanger and fans, to reduce the temperature of the hot air from the CO₂ absorber (504).

Also shown in FIG. 6 are the counterlung output vent (510) and counterlung input vent (512), where the counterlung output vent (510) is for conveying filtered air from the cooling system (508) to the counterlung (described above), and the counterlung input vent (512) is for receiving air from the counterlung to be conveyed to the user.

Also shown in FIG. 6 are elements that are shown in FIGS. 3A and 3B described above, particularly the CCR unit frame (42), the top brackets (48), the exhaust tube connector (302), which connects the user exhaust tube (34), and the inhalation tube connector (304), which connects the user inhalation tube (36).

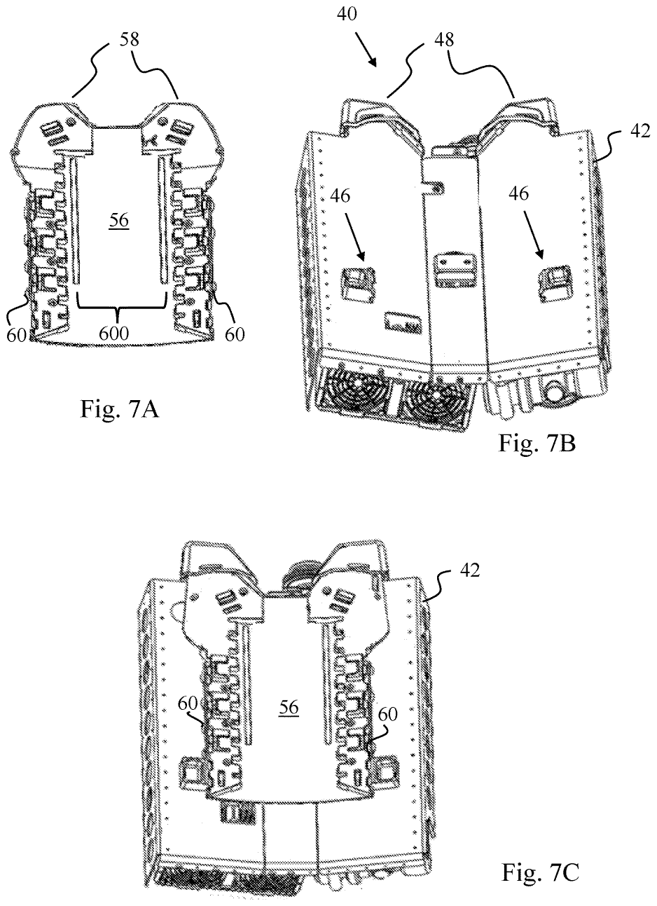

FIGS. 7A-6C are illustrations indicating how the CCR unit (40) mounts onto the back panel (56). FIG. 7A shows the front of the back panel (56) of the load-carrying backpack (50), that is, the side of the back of the back panel is shown without the backpack so that a full view of the back panel is exposed, including the top ridges (58). It is to be understood that in actual operation, the back panel remains attached to (or is an integral part of) the backpack, with the attachment secured within a central area of the back panel, for example between internal strips (600). FIG. 7B shows the CCR unit (40), also from the front, indicating the latches (46) and the top brackets (48) of the CCR unit frame (42).

FIG. 7C shows the CCR unit (40) mounted to the back panel (56), showing the top ridges (58) of the back panel mounted inside the top brackets (48) of the CCR unit frame, and the latches (46) of the CCR unit frame latched onto side edges (60) of the back panel (56).

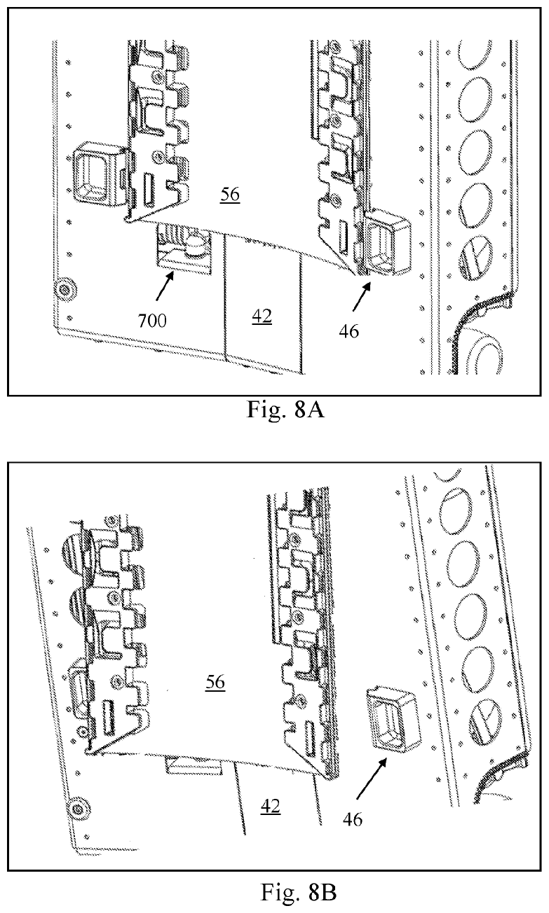

FIGS. 8A-8B are close-up illustrations of the CCR unit (40) and the back panel (56), also shown (as in FIGS. 7A-7C) without the load-carrying backpack (50) to which the back panel is affixed, to provide a close-up view of the attachment of the latches (46) to the back panel. FIG. 8A shows the back panel when clasped (i.e., latched or fastened) by the latches, and FIG. 8B shows the back panel when released from the latches. A spring-like mechanism in each latch (46) keeps each latch fastened to the back panel until the latch is pulled outward, away from the back panel, as described further herein. The latches are typically pulled outwards, away from the back panel, by a person assisting the user (i.e., the wearer) to remove the CCR unit thereby eliminating the need to remove the load-carrying backpack (50) from the wearer's back. The person assisting stands behind the user and reaches around the CCR unit to grasp the (two) latches, releasing the CCR unit from the back panel (and the rest of the load-carrying backpack to which the back panel is attached), as shown in FIG. 8B. In alternative embodiments, a single latch may be positioned to clasp the bottom of the back panel, when fit in a bottom slot (700). Alternatively, or additionally, multiple latches may be positioned on the bottom or on either side of the back panel. In certain embodiments, a release wire can be pulled to release all the latches. This can be done by the wearer or the helper, in either case, assisting the helper to remove the CCR unit in ease.

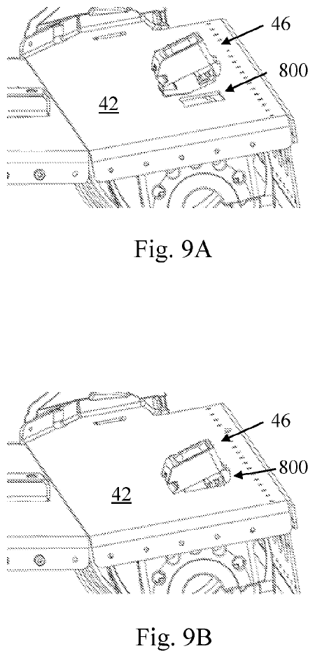

FIGS. 9A-9B are illustrations of the latch (46) of the CCR unit (40) being fit into a slot (800) of the frame (42) of the CCR unit (40), according to an embodiment of the invention. Ridges of the latch maintain a firm fit of the latch in the slot, i.e., maintain tension of the latch against the top and bottom sides of the frame surface, while allowing movement of the latch parallel to the frame surface to catch and release the back panel.

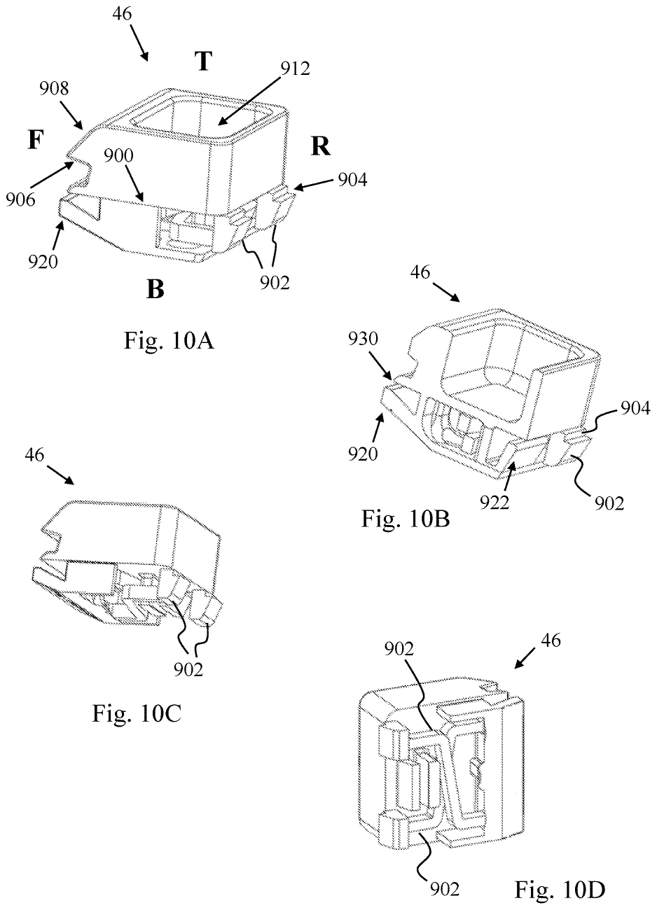

FIGS. 10A-10D are views of the latch (46) of the CCR unit (40) according to an embodiment of the invention. As described above, the latch clasps onto the back panel (56) of the load-carrying backpack (50) when the CCR unit is mounted onto the load-carrying backpack. The latch has sides that are indicated in FIG. 10A as top (T), rear (R), bottom (B), and front (F). As described above with respect to FIGS. 9A-9B, the bottom side of the latch, that is, the portion of the latch below the section marked by plane 900, fits into the frame slot (800). Two spring elements (902) have grooves (904) that press against the frame at the rear of the latch (like springs), to keep the latch in place in a forward position (i.e., towards the “front”).

As illustrated, in certain embodiments at the front of the latch there is a lip (906), which holds the back panel in place until the latch is slid back, that is, towards the rear, by applying pressure against the spring elements. The lip (906) has an inclined (i.e., “angled”) front edge (908). The back panel is fastened to the CCR unit by pressing the back panel against the inclined front edge, thereby forcing the latch towards the rear (like a typical door latch) until the back panel has cleared the lip (906).

In certain embodiments, the latch may have a top crevice (912) so that the latch may be easily pulled to the rear, away from the back panel, by a person assisting the user in removing the CCR unit. The assistant's fingers can grasp onto the crevice to facilitate pulling the latch.

FIG. 10B is a cutaway view of the side of the latch showing two ridges at the bottom of the latch that keeps the latch in place in the slot (800) of the frame, as described above with respect to FIGS. 9A-9B. A front ridge (920) and a rear ridge (922) of the latch maintain a firm fit of the latch in the slot, i.e., maintain the tension of the latch against the top and bottom sides of the frame surface, while allowing movement of the latch forward and backward. The front ridge (920) is inclined upwards and extends to create a groove (930) of about 1 cm, or for a sufficient length to prevent the latch from slipping out of the frame slot when pulled back. The back ridge (922) is inclined to permit the latch to be snapped into place in the frame slot. The latch may be replaced, if necessary, by pressing on the back ridge to free the rear side of the latch from the rear edge of the slot, thereby allowing the latch to be removed.

FIGS. 10C-10D are cutaway views of the bottom side of the latch, showing one possible design of the spring elements (902), as elastic fingers having a “Z” shape. As described above, the latch may be manufactured as one piece, for example, by 3D additive printing.

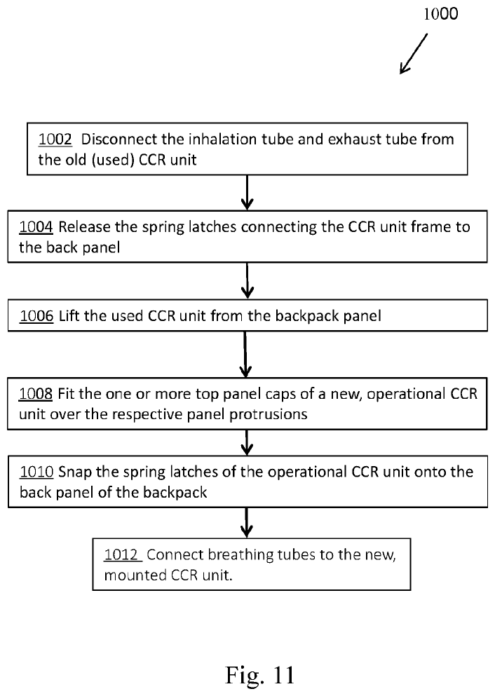

FIG. 11 is a flowchart (1000) of steps performed in removing and replacing the modular CCR unit (40) of the CCR system (20) while worn by a user, a process facilitated by the mechanisms of the present invention described above. It is understood that the steps are typically performed by a second person, who stands behind the user to facilitate fast replacement by avoiding the need to remove the entire CCR system from the user's back. The CCR unit is typically replaced during the course of a job when either the oxygen or the scrubber material is depleted. The CCR unit may further include a battery/power source powering the fan for the cooling system, which may also need replacement.

The first step (1002) of the replacement process includes disconnecting the breathing tube unit (30) from the system (20) by disconnecting the exhaust tube connector (302) from the user exhaust tube (34), and the inhalation tube connector (304) from the user inhalation tube (36), as described above with respect to FIG. 6. The quick release connections facilitate the rapid release of the breathing tubes.

At a subsequent step (1004) the latches are pulled outwards, releasing the CCR unit from the back panel. For example, the person assisting with the replacement typically puts his/her hands at the sides of the CCR unit, with palms grasping the sides of the frame and one or two fingers of each hand grasping the respective latch.

Once the CCR unit is released from the latches, the CCR unit is lifted up, freeing the top brackets of the CCR unit from the top ridges of the back panel (step 1006).

At step 1008, a new CCR unit (i.e., an operational unit supplied with the designed amounts of oxygen and clean scrubbing material) is then lifted into place so that the top brackets fit over the top ridges that protrude at the top of the back panel.

At step 1010, the CCR unit, supported by the top ridges of the back panel, is pressed against the back panel, snapping the latches of the CCR unit frame into place, so as to clasp the back panel. The weight of the CCR unit is often sufficient to snap the latches into place, but this can be further facilitated by manually pushing the CCR unit against the back panel by the helper.

At the final step (1012) of the process, the breathing tube unit (30) is reconnected to the system (20) by connecting the exhaust tube connector (302) to the user exhaust tube (34), and by connecting the inhalation tube connector (304) to the user inhalation tube (36), reversing the process described above with respect to step 1002. The quick-release connections facilitate the rapid connection of the breathing tubes.

The present invention provides a closed-circuit rebreather (CCR) system as defined above, the improvement thereof being a set of mechanisms for quick release and replacement of a modular CCR unit of the system.

### ELEMENTS ILLUSTRATED IN FIGURES

| | |
|---|---|
| closed-circuit rebreather (CCR) system | 20 |
| breathing tube unit | 30 |
| CCR unit | 40 |
| backpack | 50 |
| mouthpiece | 32 |
| exhaust tube | 34 |
| inhalation tube | 36 |
| frame of CCR unit | 42 |
| counterlung | 44 |
| latch(es) | 46 |
| top brackets of CCR unit | 48 |
| shoulder straps | 52 |
| waistband | 54 |
| back panel | 56 |
| back panel protruding top ridges | 58 |
| exhaust tube connector | 302 |
| inhalation tube connector | 304 |
| compressed oxygen cylinder | 502 |
| CO₂ absorber | 504 |
| oxygen cylinder regulator | 506 |
| cooling system | 508 |
| counterlung output vent | 510 |
| counterlung input vent | 512 |
| back panel strips (defining area joining | 600 |
| backpack) | |
| frame slot for bottom latch | 700 |
| frame slots for side latches | 800 |
| plane (virtual) dividing top and bottom | 900 |
| sections of latch | |
| spring elements of latch | 902 |
| grooves of spring elements | 904 |
| front lip of latch (for clasping back panel) | 906 |
| inclined edge of front lip | 908 |
| top crevice of latch | 912 |
| front ridge of latch | 920 |
| rear ridge of latch | 922 |
| groove of front ridge | 930 |

1. A system (20) comprising a closed-circuit rebreather (CCR) unit (40), the CCR unit (40) comprising:
a) a frame (42) having front and back sides, the front side comprising: (i) one or more top brackets (48) for mounting over one or more respective protruding ridges at the top of a back panel of a load-carrying backpack (50); and (ii) one or more quick-release latches (46) for fastening said frame (42) to said back panel,
and
b) elements for CCR operation mounted onto the back side of the frame comprising:
a compressed oxygen cylinder (502),
an oxygen regulator (506),
a carbon dioxide (CO₂) absorber (504),
an exhaust tube connector (302) for connecting a user exhaust tube (34), and
an inhalation tube connector (304) for connecting a user's inhalation tube (36),
wherein both the exhaust tube connector (302) and the inhalation tube connector (304) are quick-release connectors.

2. The system of claim 1, wherein each latch (46) comprises a set of spring elements (902) for maintaining tension of the latch onto the back panel while fastened, until the latch (46) is pulled for releasing the frame (42) from the back panel.

3. The system of claim 2, wherein said spring elements (902) are Z-shaped.

4. The system of claim 1, wherein each latch (46) is a spring-like element or consists of a spring element for maintaining tension of the latch onto the back panel while fastened, until the latch (46) is pulled for releasing the frame (42) from the back panel.

5. The system of claim 1, further comprising a breathing tube unit (30) comprising: a user mouthpiece (32), a user exhaust tube (34), and a user inhalation tube (36), wherein the user exhaust tube (34) and the user inhalation tube (36) connect the user mouthpiece (32) to the respective exhaust and inhalation tube connectors (302, 304).

6. The system of claim 1, further comprising a load-carrying backpack (50) comprising shoulder straps (52) and a back panel (56).

7. The system of claim 1, wherein the frame (42) is wider than the back panel, and wherein the one or more latches (46) are a pair of latches positioned to clasp the back panel at the outer edge of each side of the back panel, such that the latches are accessible to a person reaching around the back of the CCR unit while the CCR unit is mounted.

8. The system of claim 1, further comprising a pull-cable associated with said one or more latches (46), such that pulling thereof releases all said latches (46) from said back panel simultaneously.

9. The system of claim 1, wherein said one or more latches (46) are positioned to clasp the back panel at the bottom edge of the back panel.

10. The system of claim 1, wherein said one or more latches are mounted onto said frame (42) within a dedicated frame slot (800).

11. The system of claim 1, wherein said latches (46) are manufactured by additive 3D manufacturing as single pieces.

12. The system of claim 1, wherein the latches are made essentially entirely of polyamide.

13. The system of claim 1, further comprising a counterlung (44) providing air to the inhalation tube after scrubbing by the CO₂ absorber (504) and provision of additional oxygen from said compressed oxygen cylinder (502).

14. The system of claim 1, wherein the CCR unit (40) further comprises a cooling system (508) mounted to receive and cool air exiting from said CO₂ absorber (504).
